(19) United States
(12) Patent Application Publication
(10) Pub. No.: US 2007/0139602 A1
(43) Pub. Date: Jun. 21, 2007

(54) Liquid crystal display device with complementary bumps in liquid crystal layer

(75) Inventors: Jia-Shyong Cheng, Miao-Li (TW); Chieh-Li Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/638,774

(22) Filed: Dec. 14, 2006

(30) Foreign Application Priority Data
Dec. 16, 2005 (TW) 94222030

(51) Int. Cl. G02F 1/1339

(52) U.S. Cl. 349/155

(57) ABSTRACT

An exemplary liquid crystal display device (300) includes a TFT substrate (311) and a color filter substrate (312) opposite to the TFT substrate; a space (313) defined between the TFT and the color filter substrates; and a liquid crystal layer (314) and a plurality of bumps (315, 316) located in the space. The bumps respectively extend from inner surfaces of the TFT and the color filter substrates. The bumps extending from the TFT substrate are arranged in first horizontal rows, and the bumps extending from the color filter substrate are arranged in second horizontal rows. Each of the first rows of bumps is slightly above a corresponding second row of bumps or each of the first rows of bumps is slightly below a corresponding second row of bumps. The staggered bumps prevent the LCD panel from generating picture distortion and gravity mura, even when the liquid crystal is weighty.

### FIELD OF THE INVENTION

The present invention relates to liquid crystal display (LCD) devices, and more particularly to a liquid crystal display (LCD) device with complementary bumps in a liquid crystal layer thereof.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by some to have the potential to completely replace CRT (cathode ray tube) monitors and televisions.

Nowadays, LCD devices can be made very large for certain types of products such as LCD TVs. A large-sized LCD device may be quite heavy, and even the weight of liquid crystal contained in a liquid crystal layer (cell) of the LCD device may be considerable. If the product is used in a vertical orientation, the liquid crystal is liable to flow down and concentrate toward a bottom of the liquid crystal cell under the effect of gravity. A conventional liquid crystal cell is sandwiched between two substrates of the LCD device. Spacers or photo spacers are provided in the liquid crystal cell for maintaining a cell gap between the two substrates. These spacers help prevent the liquid crystal from drifting down too much. However, if there is a large amount of weighty liquid crystal, the spacers provide only limited control of shifting of the liquid crystal.

Referring to FIG. 6, an LCD device 100 may have an LCD panel with a display screen as large as 40 inches. Liquid crystal 104 sandwiched between a thin film transistor substrate 101 and a color filter substrate 102 is liable to drift down and gather at a bottom of the LCD device 100 because of gravity. The liquid crystal 104 presses on the thin film transistor substrate 101, the color filter substrate 102, and photo spacers 105 located between the substrates 101, 102. This pressure is liable to induce the LCD device 100 to generate picture distortion and so-called gravity mura. Moreover, because the LCD device 100 is large, it is generally equipped with a light source having high power consumption. The light source may for example be a plurality of cold cathode fluorescent lamps (CCFLs). The CCFLs are apt to generate a great deal of heat, which may make the liquid crystal expand and also become more fluid. When this happens, the gravity mura of the LCD device 100 may be even more pronounced.

Accordingly, what is needed is an LCD device that can overcome the above-described deficiencies.

### SUMMARY

An exemplary A liquid crystal display device includes a thin film transistor substrate and a color filter substrate opposite to the thin film transistor substrate; a space defined between the thin film transistor substrate and the color filter substrate; and a liquid crystal layer and a plurality of bumps located in the space. The bumps respectively extend from inner surfaces of the thin film transistor substrate and the color filter substrate. The bumps extending from the thin film transistor substrate are arranged in first horizontal rows, and the bumps extending from the color filter substrate are arranged in second horizontal rows. Each of the first rows of bumps is slightly above a corresponding second row of bumps or each of the first rows of bumps is slightly below a corresponding second row of bumps, and for any two such adjacent rows of bumps, each of the bumps in the upper row of bumps partly overlaps at least one corresponding adjacent bump in the lower row of bumps.

A liquid crystal display device includes a thin film transistor substrate and a color filter substrate opposite to the thin film transistor substrate; a space defined between the thin film transistor substrate and the color filter substrate; and a liquid crystal layer and a plurality of sets of bumps located in the space. Each set of bumps includes two first bumps disposed at one of the substrates, and a second bump disposed at the other substrate. In each set of bumps the first bumps are located above and below second bumps respectively, an upper one of the first bumps partly overlaps the second bump, and the second bump partly overlaps a lower one of the first bumps.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a front plan view of an LCD device according to a first embodiment of the present invention.

FIG. 2 is a rear plan view of the LCD device of FIG. 1.

FIG. 3 is an enlarged, side cross-sectional view of part of an LCD panel of the LCD device of FIG. 1, showing two opposite substrates having liquid crystal and bumps therebetween.

FIG. 4 is similar to FIG. 3, but showing a corresponding view of part of an LCD panel in the case of an LCD device according to a second embodiment of the present invention.

FIG. 5 is an enlarged view of part of the LCD panel shown in FIG. 4, but with the LCD panel oriented horizontally.

FIG. 6 is a side cross-sectional view of part of an LCD panel of a conventional LCD device.

### DETAILED DESCRIPTION OF PREFERRED EMBODIMENTS

Reference will now be made to the drawings to describe preferred and exemplary embodiments of the present invention in detail.

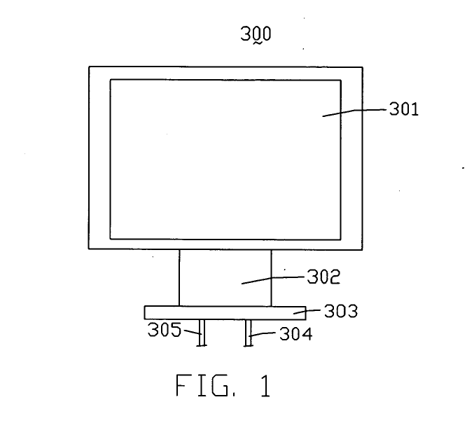

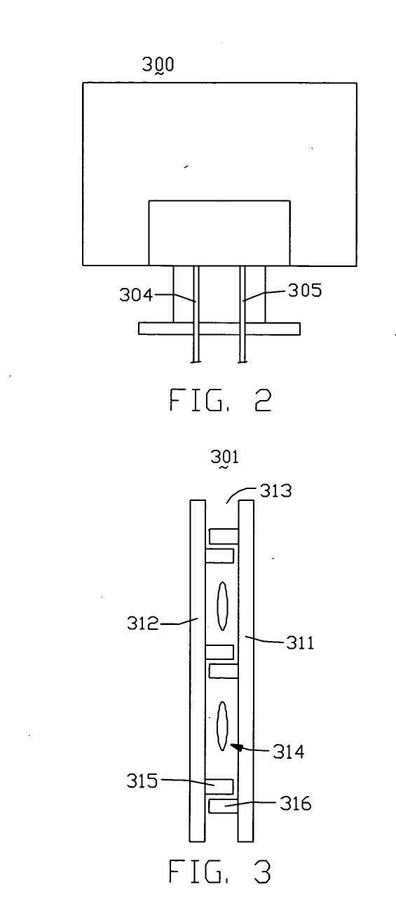

Referring to FIGS. 1-2, an LCD device 300 according to a first embodiment of the present invention includes an LCD panel 301, a supporting member 302, a base 303, a power supply terminal 304, and a signal input terminal 305. The supporting member 302 is engaged with the base 303, and the LCD panel 302 is supported on the supporting member 302. Electric power is supplied to the LCD panel 301 via the power supply terminal 304, and signals are inputted to the LCD panel 301 via the signal input terminal 305.

Referring also to FIG. 3, this is an enlarged, side cross-sectional view of part of the LCD panel 301. The LCD panel 301 includes a color filter substrate 311, a thin film transistor substrate 312 opposite to and spaced apart from the color filter substrate 311, a space 313 defined between the two substrates 311 and 312, and a liquid crystal layer 314 and a plurality of bumps 315 and 316 located in the space 313. The bumps 315 and 316 are disposed on inner surfaces (not labeled) of the substrates 311 and 312 respectively, and are for preventing liquid crystal molecules of the liquid crystal layer 314 from flowing toward and gathering at a bottom portion of the LCD panel 301.

The bumps 315 perpendicularly extend from the inner surface of the thin film transistor substrate 312, and the bumps 316 perpendicularly extend from the inner surface of the color filter substrate 311. The bumps 315 are arranged in horizontal rows, and the bumps 316 are arranged in horizontal rows slightly below the corresponding rows of bumps 315. Each of the bumps 315 and 316 is generally block-shaped. The bumps 316 in each row of bumps 316 are slightly offset from the bumps 315 in the adjacent row of bumps 315. That is, each bump 315 partly overlaps at least one corresponding adjacent bump 316. In one embodiment, each bump 315 partly overlaps two corresponding adjacent bumps 316. The paired rows of bumps 315, 316 are evenly spaced apart from each other along a height of the LCD panel 301. In alternative embodiments, each bump 315, 316 may be cylindrical, polygonal, or have another suitable shape.

Further or alternatively, the bumps 315 may positioned corresponding to scanning lines (not shown) and common lines (not shown) of the thin film transistor substrate 312, and the bumps 316 may positioned corresponding to a black matrix (not shown) of the color filter substrate 311.

Unlike with the above-described conventional LCD device 100, the staggered bumps 315 and 316 of the LCD device 300 can prevent the liquid crystal from flowing down and gathering at a bottom portion of the LCD device 300 when the LCD device 300 is vertically oriented. Therefore the bumps 315 and 316 can help prevent the LCD device 300 from generating picture distortion and gravity mura, even when the liquid crystal is weighty.

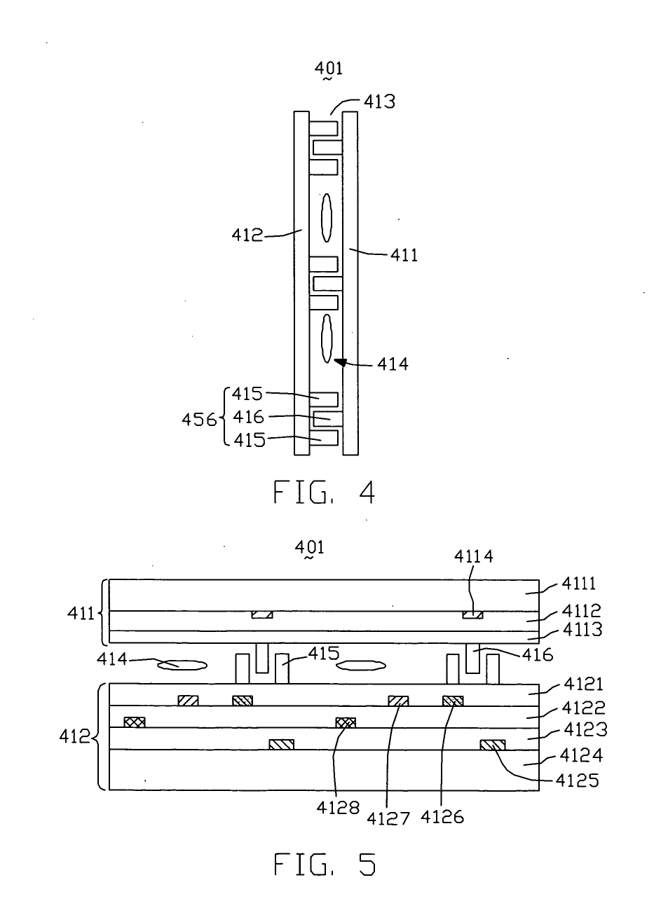

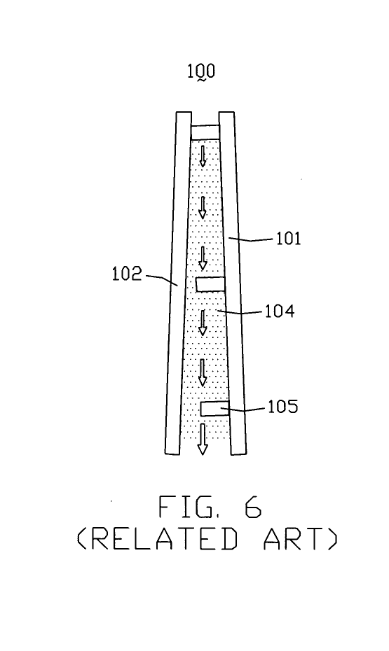

Referring to FIG. 4, this is an enlarged, side cross-sectional view of part of an LCD panel of an LCD device according to a second embodiment of the present invention. The LCD panel 401 is typically an in-plane switching (IPS) LCD panel. The LCD panel 401 includes a thin film transistor substrate 412, a color filter substrate 411 opposite to and spaced apart from the thin film transistor substrate 412, a space 413 defined between the two substrates 411 and 412, and a liquid crystal layer 414 and a plurality of sets of bumps 456 located in the space 413. Each set of bumps 456 includes two first bumps 415 disposed on an inner surface (not labeled) of the thin film transistor substrate 412, and a second bump 416 disposed on an inner surface (not labeled) of the color filter substrate 411. The two first bumps 415 and the second bump 416 are staggered. That is, the second bump 416 is located between the two first bumps 415 above and below. The first bumps 415 and the second bump 416 partly overlap one another. In particular, a top one of the first bumps 415 partly overlaps the second bump 416, and the second bump 416 partly overlaps a bottom one of the first bumps 415. The sets of bumps 456 are arranged in horizontal rows, which are evenly spaced apart from each other along a height of the LCD panel 401. Further, each set of bumps 456 is located generally midway between two nearest sets of bumps 456 in the row of sets of bumps 456 below, and located generally midway between two nearest sets of bumps 456 in the row of sets of bumps 456 above.

Also referring to FIG. 5, the thin film transistor-substrate 412 includes a glass substrate 4124, a plurality of gate lines 4125 formed on an inner surface of the glass substrate 4124, an insulating layer 4123 covering the gate lines 4125 and the glass substrate 4124, a plurality of pixel electrodes 4128 formed on the insulating layer 4123, a passivation layer 4122 covering the pixel electrodes 4128 and the insulating layer 4123, a plurality of common electrodes 4127 and common lines 4126 formed on the passivation layer 4122, and an alignment film 4121 covering the common electrodes 4127, the common lines 4126, and the passivation layer 4122. For each set of bumps 456, the two first bumps 415 are positioned corresponding to a respective one of the common lines 4126 and a respective one of the gate lines 4125, respectively.

The color filter substrate 411 includes a glass substrate 4111, a black matrix 4114 formed on an inner surface of the glass substrate 4111, a color filter 4112 formed on the black matrix 4114 and the inner surface of the glass substrate 4111, and an alignment film 4113 covering the color filter 4112. The second bumps 416 are positioned corresponding to the black matrix 4114.

The staggered arrangement of the sets of bumps 456 and the overlapping configuration of the first and second bumps 415, 416 in each set of bumps 456 can prevent liquid crystal in the liquid crystal layer 414 from flowing down and gathering at a bottom portion of the LCD panel 401 when the LCD panel 401 is vertically oriented. Therefore the sets of bumps 456 having the first and second bumps 415, 416 can help prevent the LCD panel 401 from generating picture distortion and gravity mura, even when the liquid crystal is weighty. Further, the positioning of the first bumps 415 corresponding to the common lines 4126 and the gate lines 4125 and the positioning of the second bumps 416 corresponding to the black matrix 4114 help maintain an aperture ratio of the LCD panel 401.

Various modifications and alterations are possible within the ambit of the description herein. For example, each set of bumps 456 of the LCD panel 401 can have only a single first bump 415, which is positioned corresponding to a selected, respective one of the common lines 4126 and gate lines 4125.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a thin film transistor substrate and a color filter substrate opposite to the thin film transistor substrate;
a space defined between the thin film transistor substrate and the color filter substrate; and
a liquid crystal layer and a plurality of bumps located in the space;
wherein the bumps respectively extend from inner surfaces of the thin film transistor substrate and the color filter substrate, the bumps extending from the thin film transistor substrate are arranged in first horizontal rows, the bumps extending from the color filter substrate are arranged in second horizontal rows, each of the first rows of bumps is slightly above a corresponding second row of bumps or each of the first rows of bumps is slightly below a corresponding second row of bumps, and for any two such adjacent rows of bumps, each of the bumps in the upper row of bumps partly overlaps at least one corresponding adjacent bump in the lower row of bumps.

2. The liquid crystal display device as claimed in claim 1, wherein each of the first rows of bumps extending from the thin film transistor substrate are slightly above the corresponding second row of bumps extending from the color filter substrate.

3. The liquid crystal display device as claimed in claim 2, wherein the thin film transistor substrate comprises a plurality of gate lines, and the bumps extending from the thin film transistor substrate are positioned corresponding to the gate lines.

4. The liquid crystal display device as claimed in claim 2, wherein the thin film transistor substrate comprises a plurality of common lines, and the bumps extending from the thin film transistor substrate are positioned corresponding to the common lines.

5. The liquid crystal display device as claimed in claim 2, wherein the color filter substrate comprises a black matrix, the bumps extending from the color filter substrate are positioned corresponding to the black matrix.

6. A liquid crystal display device, comprising:
a thin film transistor substrate and a color filter substrate opposite to the thin film transistor substrate;
a space defined between the thin film transistor substrate and the color filter substrate; and
a liquid crystal layer and a plurality of sets of bumps located in the space;
wherein each set of bumps comprises two first bumps disposed at one of the substrates, and a second bump disposed at the other substrate, and in each set of bumps the first bumps are located above and below second bumps respectively, an upper one of the first bumps partly overlaps the second bump, and the second bump partly overlaps a lower one of the first bumps.

7. The liquid crystal display device as claimed in claim 6, wherein the sets of bumps are arranged in horizontal rows, and the rows of sets of bumps are evenly spaced apart from each other.

8. The liquid crystal display device as claimed in claim 6, wherein each set of bumps is located generally midway between two nearest sets of bumps in the row of sets of bumps below, and located generally midway between two nearest sets of bumps in the row of sets of bumps above.

9. The liquid crystal display device as claimed in claim 6, wherein the thin film transistor substrate further comprises a plurality of common lines and a plurality of gate lines, and the first bumps disposed at the thin film transistor substrate are positioned corresponding to the common lines and the gate lines respectively.

10. The liquid crystal display device as claimed in claim 6, wherein the color filter substrate further comprises a black matrix, and the second bumps disposed at the color filter substrate are positioned corresponding to the black matrix.

11. A liquid crystal display device, comprising:
a thin film transistor substrate and a color filter substrate opposite to the thin film transistor substrate;
a space defined between the thin film transistor substrate and the color filter substrate; and
a liquid crystal layer and a plurality of bumps located in the space;
wherein the bumps respectively extend from inner surfaces of the thin film transistor substrate and the color filter substrate, the bumps extending from the thin film transistor substrate are arranged in first horizontal rows, the bumps extending from the color filter substrate are arranged in second horizontal rows,
one of the bumps in the first horizontal rows closely confronts at least another one of the bumps in the second horizontal rows in a horizontal direction under a greatly overlapping situation in said horizontal direction.
